(19) United States
(12) Patent Application Publication
(10) Pub. No.: US 2014/0045488 A1
(43) Pub. Date: Feb. 13, 2014

(54) APPARATUSES AND METHODS FOR RECOVERING SERVICE FROM REJECTED SIGNALING PROCEDURE DUE TO NETWORK FAILURE

(71) Applicant: ACER INCORPORATED, New Taipei City (TW)

(72) Inventor: Tsung-Yo CHENG, New Taipei City (TW)

(73) Assignee: ACER INCORPORATED, New Taipei City (TW)

(21) Appl. No.: 13/846,015

(22) Filed: Mar. 18, 2013

Related U.S. Application Data
(60) Provisional application No. 61/680,848, filed on Aug. 8, 2012.

(51) Int. Cl. H04W 24/00

(52) U.S. Cl. CPC H04W 24/00
USPC 455/423

(57) ABSTRACT

A mobile communication device is provided with a wireless module and a controller module. The wireless module performs wireless transmissions and receptions to and from a first Public Land Mobile Network (PLMN) and a second PLMN. The controller module performs a signaling procedure with the first PLMN via the wireless module, and performs a PLMN selection procedure via the wireless module without retrying the signaling procedure with the first PLMN, in response to the signaling procedure being failed with a rejection cause indicating a network failure.

### CROSS REFERENCE TO RELATED APPLICATIONS

This Application claims priority of U.S. Provisional Application No. 61/680,848, filed on Aug. 8, 2012, and the entirety of which is incorporated by reference herein.

### BACKGROUND OF THE INVENTION

1. Field of the Invention

The invention generally relates to the operation of a User Equipment (UE) during a signaling procedure with a Public Land Mobile Network (PLMN), and more particularly, to apparatuses and methods for recovering service from a signaling procedure rejected with network failure.

2. Description of the Related Art

With growing demand for ubiquitous computing and networking, various wireless technologies have been developed, such as the Wireless Local Area Network (WLAN) technologies, including the Wireless Fidelity (WiFi) technology, Bluetooth technology, and the Zigbee technology, etc., and also, the cellular technologies, including the Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA2000) technology, Time Division-Synchronous Code Division Multiple Access (TD-SCDMA) technology, Worldwide Interoperability for Microwave Access (WiMAX) technology, Long Term Evolution (LTE) technology, Time-Division LTE (TD-LTE) technology, and LTE-Advanced technology, etc.

For user convenience and flexibility, most User Equipments (UEs) (or may be referred to as Mobile Stations (MSs)) nowadays support more than one wireless technology, and most Public Land Mobile Networks (PLMNs) support multiple wireless technologies for providing wireless services to the UEs. Taking a UE supporting the GSM/GPRS/EDGE technology, the WCDMA technology, and the LTE technology for example, it may camp on a PLMN to obtain wireless services using one of the supported wireless technologies. While the UE is camped on a PLMN, it may perform signaling procedures, such as attach procedures, location update procedures, routing area update procedures, and/or tracking area update procedures, with the PLMN.

However, there are situations where the network element(s), e.g., Base Station (BS), Node-B, or others, of the PLMN in the area of the UE's location may be under maintenance, e.g., backbone environment fixing or system configuration updates. In such cases, the signaling procedure performed with the PLMN by the UE will be rejected due to network failure, and according to chapter 5 of the 3GPP TS 24.301 specification and chapter 4 of the 3GPP TS 24.008 specification, the UE will keep retrying the signaling procedure for several times with the same PLMN using the same wireless technology as it earlier used for camping on the PLMN. Unfavorably, during this time, the UE cannot obtain wireless services, and even worse, the maintenance of the network element(s) may take a long time. As a result, the user of the UE may unexpectedly experience a long break of services.

### BRIEF SUMMARY OF THE INVENTION

In order to solve the aforementioned problem, the invention proposes apparatuses and methods for a UE to recover service from a signaling procedure rejected with network failure, by performing a PLMN selection procedure with different PLMNs or with the same PLMN using different wireless technologies without retrying the signaling procedure.

In one aspect of the invention, a mobile communication device is provided. The mobile communication device comprises a wireless module and a controller module. The wireless module performs wireless transmissions and receptions to and from a first Public Land Mobile Network (PLMN) and a second PLMN. The controller module performs a signaling procedure with the first PLMN via the wireless module, and performs a PLMN selection procedure via the wireless module without retrying the signaling procedure with the first PLMN, in response to the signaling procedure being failed with a rejection cause indicating a network failure.

In another aspect of the invention, a method for a mobile communication device to recover service from a signaling procedure rejected with a network failure is provided. The method comprises the steps of performing the signaling procedure with a first PLMN; and performing a PLMN selection procedure without retrying the signaling procedure with the first PLMN, in response to the signaling procedure being failed with a rejection cause indicating a network failure.

Other aspects and features of the present invention will become apparent to those with ordinarily skill in the art upon review of the following descriptions of specific embodiments of the mobile communication devices and the methods for recovering service from a signaling procedure rejected with a network failure.

### BRIEF DESCRIPTION OF DRAWINGS

The invention can be more fully understood by reading the subsequent detailed description and examples with references made to the accompanying drawings, wherein:

FIG. 1 is a block diagram of a wireless communications environment according to an embodiment of the invention;

FIG. 2 is a block diagram illustrating the mobile communication device 110 according to an embodiment of the invention;

FIG. 3 is a flow chart illustrating the method for a mobile communication device to recover service from a signaling procedure rejected with network failure according to an embodiment of the invention; and

FIG. 4 is a flow chart illustrating the method for a mobile communication device to recover service from a signaling procedure rejected with network failure according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

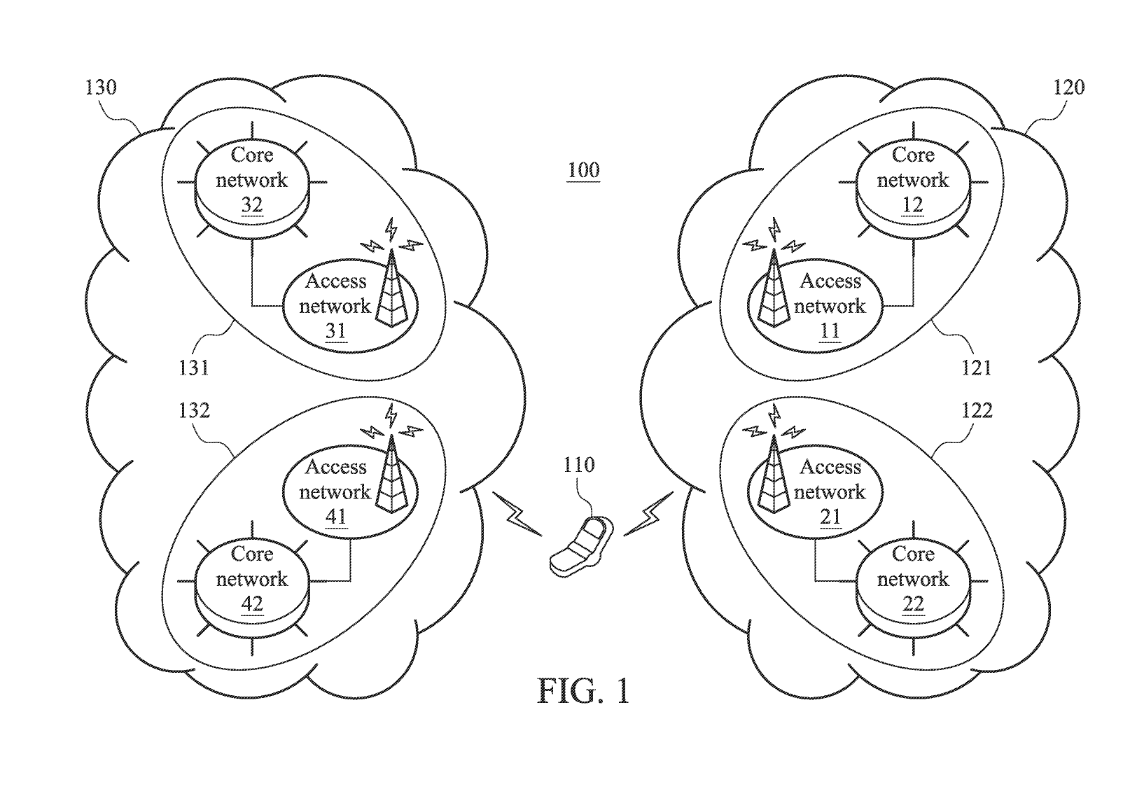

FIG. 1 is a block diagram of a wireless communications environment according to an embodiment of the invention. The wireless communications environment 100 comprises a mobile communication device 110 and two PLMNs 120 and 130, wherein the mobile communication device 110 may selectively camp on one of the PLMNs 120 and 130 to obtain wireless services. Each of the PLMNs 120 and 130 comprises at least two service networks utilizing different wireless technologies. Specifically, the PLMN 120 comprises the service networks 121 and 122, and the PLMN 130 comprises the service networks 131 and 132, wherein each of the service networks 121, 122, 131, and 132 comprises an access network and a core network.

For example, the PLMN 120 may be deployed by an operator A, and the service network 121 may be a Universal Mobile Telecommunications System (UMTS), wherein the access network 11 may be a Universal Terrestrial Radio Access Network (UTRAN) and the core network 12 may be a General Packet Radio Service (GPRS) core which includes a Home Location Register (HLR), at least one Serving GPRS Support Node (SGSN), and at least one Gateway GPRS Support Node (GGSN), while the service network 122 may be an LTE/LTE-Advanced system, the access network 21 may be an Evolved-UTRAN (E-UTRAN) and the core network 22 may be an Evolved Packet Core (EPC) which includes a Home Subscriber Server (HSS), Mobility Management Entity (MME), Serving Gateway (S-GW), and Packet Data Network Gateway (PDN-GW or P-GW).

The PLMN 130 may be deployed by an operator B, and the service network 131 may be a GPRS/EDGE system, wherein the access network 31 may be a Base Station Subsystem (BSS) and the core network 32 may be a GPRS core which includes an HLR, at least one SGSN, and at least one GGSN, while the service network 132 may be a UMTS, and the access network 41 may be a UTRAN and the core network 42 may be a GPRS core which includes an HLR, at least one SGSN, and at least one GGSN.

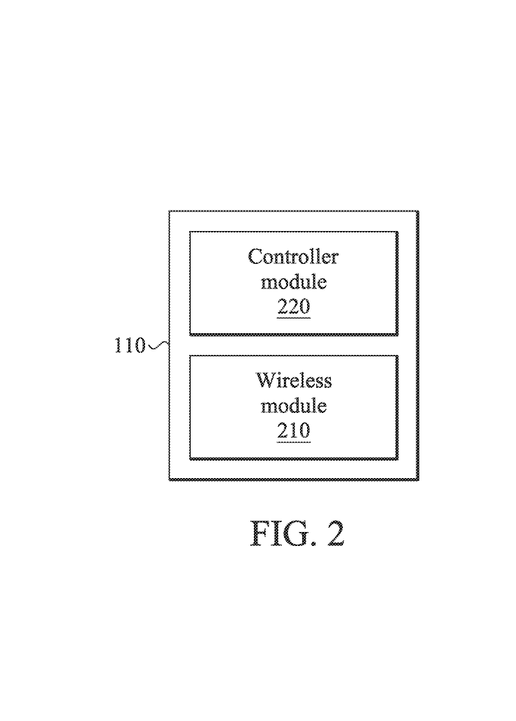

The mobile communication device 110 may be a smart phone, a panel Personal Computer (PC), a laptop computer, or any computing device supporting at least two of the wireless technologies utilized by the service networks 121 and 122 of the PLMN 120 and the service networks 131 and 132 of the PLMN 130. FIG. 2 is a block diagram illustrating the mobile communication device 110 according to an embodiment of the invention. The mobile communication device 110 comprises a wireless module 210 and a controller module 220. The wireless module 210 is responsible for performing the functionality of wireless transmissions and receptions to and from the service networks 121 and 122 of the PLMN 120 and the service networks 131 and 132 of the PLMN 130. The controller module 220 is responsible for controlling the operations of the wireless module 210, and other functional components (not shown), such as a display unit and/or keypad serving as the Man-Machine Interface (MMI), a storage unit storing the program codes of applications or communication protocols, or others. Also, the controller module 220 controls the wireless module 210 for performing the method for recovering service from a signaling procedure rejected with network failure.

To further clarify, the wireless module 210 may be a Radio Frequency (RF) unit (not shown), and the controller module 220 may be a general-purpose processor or a Micro Control Unit (MCU) of a baseband unit (not shown). The baseband unit may contain multiple hardware devices to perform baseband signal processing, including analog to digital conversion (ADC)/digital to analog conversion (DAC), gain adjusting, modulation/demodulation, encoding/decoding, and so on. The RF unit may receive RF wireless signals, convert the received RF wireless signals to baseband signals, which are processed by the baseband unit, or receive baseband signals from the baseband unit and convert the received baseband signals to RF wireless signals, which are later transmitted. The RF unit may also contain multiple hardware devices to perform radio frequency conversion. For example, the RF unit may comprise a mixer to multiply the baseband signals with a carrier oscillated in the radio frequency of the mobile communication system, wherein the radio frequency may be 900 MHz, 1800 MHz, or 1900 MHz utilized in the GPRS/EDGE technology, 900 MHz, 1900 MHz, or 2100 MHz utilized in the WCDMA technology, or 900 MHz, 2100 MHz, or 2.6 GHz utilized in LTE/LTE-Advanced technology, or others depending on the wireless technology in use.

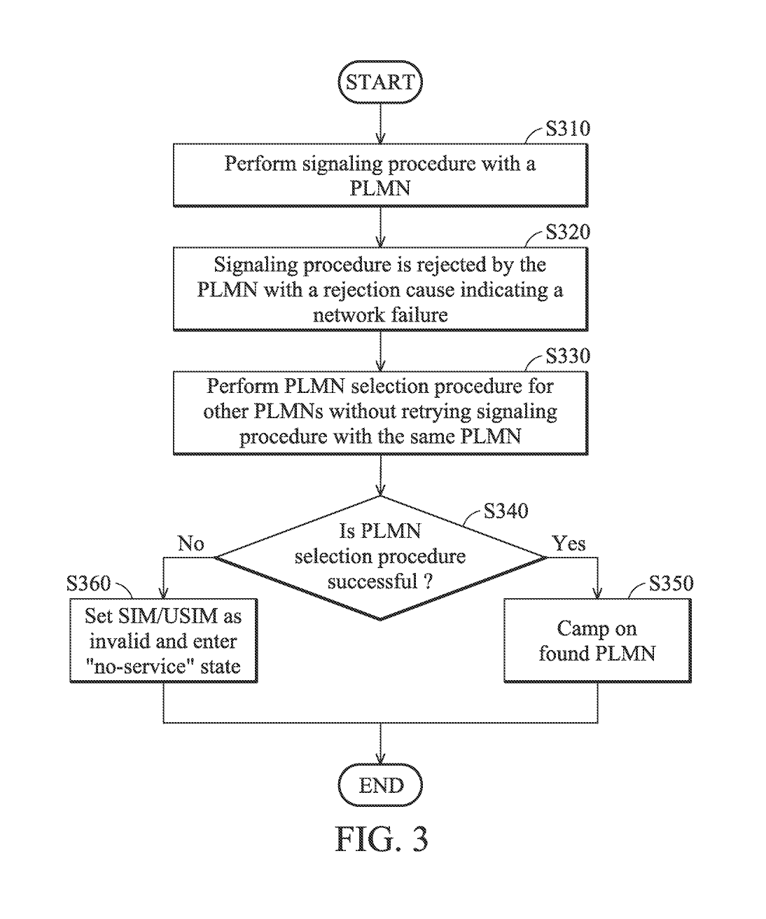

FIG. 3 is a flow chart illustrating the method for a mobile communication device to recover service from a signaling procedure rejected with network failure according to an embodiment of the invention. In this embodiment, the mobile communication device is initially camped on a PLMN. To begin, the mobile communication device performs a signaling procedure with the PLMN (step S310). Specifically, the signaling procedure may be an attach procedure, a location update procedure, a routing area update procedure, or a tracking area update procedure. Next, the signaling procedure is rejected by the PLMN with a rejection cause indicating a network failure (step S320). Specifically, the rejection cause may be included in an ATTACH REJECT message, a LOCATION UPDATE REJECT message, a ROUTING AREA UPDATE REJECT message, or a TRACKING AREA UPDATE REJECT message, and it is set to a value of 17 which means the signaling procedure is rejected with a network failure.

In response to the signaling procedure being rejected with a network failure, the mobile communication device performs a PLMN selection procedure for other PLMNs without retrying the signaling procedure with the PLMN (step S330). Note that, the PLMN selection procedure is performed for the PLMNs other than the PLMN which the mobile communication device was camped on initially. That is, the PLMN selection procedure is performed for finding any suitable PLMN other than the one for which the signaling procedure was rejected. Subsequently, it is determined whether the PLMN selection procedure is successful to find another PLMN (step S340). If so, the mobile communication device camps on the found PLMN (step S350). Otherwise, if the PLMN selection procedure fails, the mobile communication device sets the Subscriber Identity Module (SIM) or Universal SIM (USIM), which is coupled to the mobile communication device, as invalid, and enters the “no-service” state (step S360).

Note that, unlike the conventional operation of UE, the mobile communication device in the embodiment of FIG. 3 does not retry the signaling procedure with the same PLMN and performs the PLMN selection procedure for other PLMNs in response to failure of the signaling procedure with a rejection cause indicating a network failure, so that it may camp on another PLMN to obtain wireless services as soon as possible.

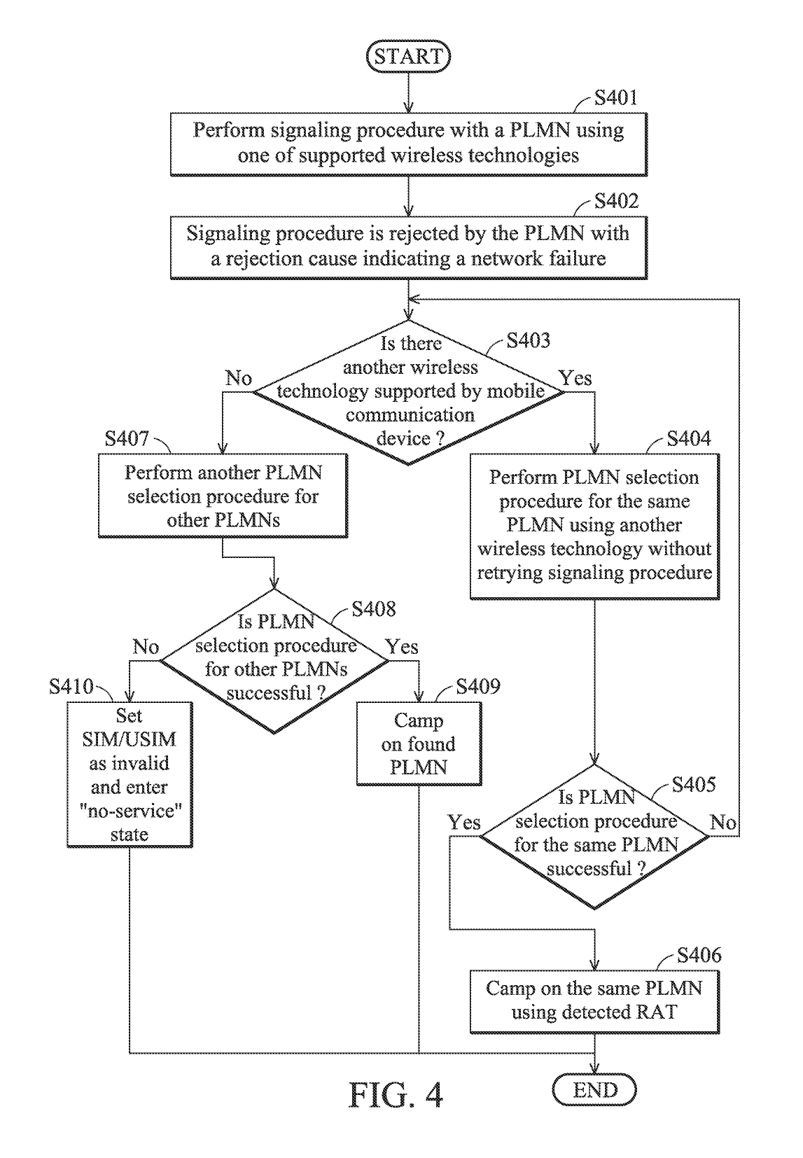

FIG. 4 is a flow chart illustrating the method for a mobile communication device to recover service from a signaling procedure rejected with network failure according to another embodiment of the invention. Similarly, the mobile communication device is initially camped on a PLMN. To begin, the mobile communication device performs a signaling procedure with the PLMN using one of the supported wireless technologies (step S401), and the signaling procedure is rejected by the PLMN with a rejection cause indicating a network failure (step S402). Specifically, the signaling procedure may be an attach procedure, a location update procedure, a routing area update procedure, or a tracking area update procedure. Next, it is determined whether there is another wireless technology supported by the mobile communication device (step S403). If so, the mobile communication device performs a PLMN selection procedure for the same PLMN using another wireless technology without retrying the signaling procedure using the same wireless technology (step S404).

After that, it is determined whether the PLMN selection procedure for the same PLMN is successful to detect another Radio Access Technology (RAT) utilized by the PLMN (step S405). If so, the mobile communication device camps on the same PLMN using the detected RAT (step S406). Specifically, the detected RAT is the same as the wireless technology used in the step S404. Otherwise, if the PLMN selection procedure for the same PLMN fails, the method proceeds to step S403.

Subsequent to the step S403, if there is no other wireless technology supported by the mobile communication device (i.e., all of the supported wireless technologies have been tried), the mobile communication device performs another PLMN selection procedure for other PLMNs (step S407). Note that, the PLMN selection procedure in the step S407 is performed for the PLMNs other than the PLMN which the mobile communication device was camped on initially. That is, the PLMN selection procedure in the step S407 is performed for finding any suitable PLMN other than the one for which the signaling procedure was rejected. Next, it is determined whether the PLMN selection procedure is successful to find another PLMN (step S408). If so, the mobile communication device camps on the found PLMN (step S409). Otherwise, if the PLMN selection procedure fails, the mobile communication device sets the SIM/USIM, which is coupled to the mobile communication device, as invalid, and enters the “no-service” state (step S410).

Note that, unlike the conventional operation of UE, the mobile communication device in the embodiment of FIG. 4 does not retry the signaling procedure using the same wireless technology, and instead, it performs the PLMN selection procedure for the same PLMN using another wireless technology in response to failure of the signaling procedure with a rejection cause indicating a network failure, so that it may camp on the same PLMN with another RAT to obtain wireless services as soon as possible.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the invention shall be defined and protected by the following claims and their equivalents.

What is claimed is:

1. A mobile communication device, comprising:
a wireless module performing wireless transmissions and receptions to and from a first Public Land Mobile Network (PLMN) and a second PLMN; and
a controller module performing a signaling procedure with the first PLMN via the wireless module, and performing a PLMN selection procedure via the wireless module without retrying the signaling procedure with the first PLMN, in response to the signaling procedure being failed with a rejection cause indicating a network failure.

2. The mobile communication device of claim 1, wherein the signaling procedure is an attach procedure, a location update procedure, a routing area update procedure, or a tracking area update procedure.

3. The mobile communication device of claim 1, wherein the signaling procedure is performed with the first PLMN using a first wireless technology, and the PLMN selection procedure is performed only for the first PLMN using a second wireless technology.

4. The mobile communication device of claim 3, wherein the controller module further performs another PLMN selection procedure for the second PLMN via the wireless module, in response to failure of the PLMN selection procedure only for the first PLMN.

5. The mobile communication device of claim 4, wherein the controller module further sets a Subscriber Identity Module (SIM) or a Universal SIM (USIM) coupled to the mobile communication device as invalid, in response to failure of the PLMN selection procedure for the second PLMN.

6. The mobile communication device of claim 1, wherein the PLMN selection procedure is performed for the second PLMN.

7. The mobile communication device of claim 5, wherein the controller module further sets a Subscriber Identity Module (SIM) or a Universal SIM (USIM) coupled to the mobile communication device as invalid, in response to failure of the PLMN selection procedure for the second PLMN.

8. The mobile communication device of claim 1, wherein the controller module further camps on the first PLMN or the second PLMN in response to success of the PLMN selection procedure.

9. The mobile communication device of claim 2, wherein the first wireless technology is one of a General Packet Radio Service (GPRS) technology, an Enhanced Data rates for Global Evolution (EDGE) technology, a Wideband Code Division Multiple Access (WCDMA) technology, and a Long Term Evolution (LTE) technology, and the first wireless technology is another one of the GPRS technology, the EDGE technology, the WCDMA technology, and the LTE technology.

10. A method for a mobile communication device to recover service from a signaling procedure rejected with a network failure, comprising:
performing the signaling procedure with a first PLMN; and
performing a PLMN selection procedure without retrying the signaling procedure with the first PLMN, in response to the signaling procedure being failed with a rejection cause indicating a network failure.

11. The method of claim 10, wherein the signaling procedure is an attach procedure, a location update procedure, a routing area update procedure, or a tracking area update procedure.

12. The method of claim 10, wherein the signaling procedure is performed with the first PLMN using a first wireless technology, and the PLMN selection procedure is performed only for the first PLMN using a second wireless technology.

13. The method of claim 12, further comprising:
performing another PLMN selection procedure for the second PLMN, in response to failure of the PLMN selection procedure only for the first PLMN.

14. The method of claim 13, further comprising:
setting a Subscriber Identity Module (SIM) or a Universal SIM (USIM) coupled to the mobile communication device as invalid, in response to failure of the PLMN selection procedure for the second PLMN.

15. The method of claim 10, wherein the PLMN selection procedure is performed for the second PLMN.

16. The method of claim 15, further comprising:
setting a Subscriber Identity Module (SIM) or a Universal SIM (USIM) coupled to the mobile communication device as invalid, in response to failure of the PLMN selection procedure for the second PLMN.

17. The method of claim 10, further comprising:
camping on the first PLMN or the second PLMN in response to success of the PLMN selection procedure.

18. The method of claim 12, wherein the first wireless technology is one of a General Packet Radio Service (GPRS) technology, an Enhanced Data rates for Global Evolution (EDGE) technology, a Wideband Code Division Multiple Access (WCDMA) technology, and a Long Term Evolution (LTE) technology, and the first wireless technology is another one of the GPRS technology, the EDGE technology, the WCDMA technology, and the LTE technology.
